(19) United States
(12) Patent Application Publication
(10) Pub. No.: US 2025/0252057 A1
(43) Pub. Date: Aug. 7, 2025

(54) METHOD OF REDUCING CACHE THRASHING IN A PROCESSING SYSTEM AND RELATED PROCESSING SYSTEM

(71) Applicant: MEDIATEK INC., Hsinchu City (TW)

(72) Inventors: Yu-Sheng Lin, Hsinchu City (TW); Yoav Harel, San Jose, CA (US); Chengping Luo, San Jose, CA (US); You-Ming Tsao, Hsinchu City (TW); Yu Bai, San Jose, CA (US)

(73) Assignee: MEDIATEK INC., Hsinchu City (TW)

(21) Appl. No.: 19/035,930

(22) Filed: Jan. 24, 2025

Related U.S. Application Data
(60) Provisional application No. 63/627,825, filed on Feb. 1, 2024.

(51) Int. Cl. G06F 12/0877

(52) U.S. Cl. CPC G06F 12/0877; G06F 2212/60

(57) ABSTRACT

A method of reducing cache thrashing in a processing system is provided. M threads are issued to process a workload, and a memory access request associated with the M threads is transmitted to a first-level cache of the processing system. The memory access request is then transmitted to a second-level cache of the processing system in response to the first cache miss at the first-level cache. The memory access request is transmitted to a main memory of the processing system in response to the second cache miss at the second-level cache. The value of M is decreased when the relationship between the hit rates of the second-level cache and the first-level cache satisfies a predetermined criterion. A storage capacity and an access latency of the second-level cache are higher than those of the first-level cache.

### CROSS REFERENCE TO RELATED APPLICATIONS

This application claims the benefit of U.S. Provisional Application No. 63/627,825, filed on Feb. 1, 2024. The content of the application is incorporated herein by reference.

### BACKGROUND

Through the history of computers, processing power increases at a higher rate than memory access speed. As bulk storage or main memory can't keep up with application demands, intermediate cache storage resources have been introduced for reducing data access times, decreasing access latency and improving input/output (I/O) throughput.

Some conventional processors leverage massive multithreading as a technique for hiding latency and achieving high performance. Regularly structured, compute-intensive applications can readily utilize the high peak memory bandwidth and ample computational resources of a processing unit to great effect. In particular, regularly structured applications with high spatial and temporal locality can efficiently utilize cache resources. However, not all applications can be re-factored to exhibit regular control flow and memory access patterns, and many emerging applications suffer from inefficient utilization of cache resources. Specifically, applications can suffer from cache thrashing and high miss rate due to large thread count, small cache sizes, and limited cache capacity per thread.

Cache thrashing occurs when there are so many active threads that when one thread needs to allocate space on the cache, it clears the data other threads are still using. Such a process of clearing and retrieving the data later is known as cache eviction. To build an efficient processing system, there is a need for a method to detect cache thrashing, reduce the thread count, and thus reduce cache eviction.

### SUMMARY

The present invention provides a method of reducing cache thrashing in a processing system. The method includes issuing M threads to process a workload; transmitting a memory access request associated with the M threads to a first-level cache of the processing system and determining whether a first cache hit or a first cache miss occurs at the first-level cache; transmitting the memory access request associated with the M threads to a second-level cache of the processing system in response to the first cache miss and determining whether a second cache hit or a second cache miss occurs at the second-level cache; transmitting the memory access request associated with the M threads to a main memory of the processing system in response to the second cache miss; determining whether a relationship between a first hit rate of the first-level cache and a second hit rate of the second-level cache satisfies a predetermined criterion; and decreasing a value of M when the predetermined criterion is satisfied. A storage capacity of the second-level cache is higher than a storage capacity of the first-level cache. An access latency of the second-level cache is higher than an access latency of the first-level cache. M is an integer larger than 1.

The present invention also provides a processing system which reduces cache thrashing and includes a plurality of processing cores, a first-level cache with a first storage capacity and a first access latency, a second-level cache with a second storage capacity and a second access latency, a main memory and a scheduler. The first-level cache is configured to receive a memory access request associated with M threads and determine whether a first cache hit or a first cache miss occurs at the first-level cache. The second-level cache is configured to receive the memory access request associated with the M threads from the first-level cache in response to a first cache miss at the first-level cache and determine whether a second cache hit or a second cache miss occurs at the second-level cache. The main memory is configured to receive the memory access request associated with the M threads from the second-level cache in response to a second cache miss at the second-level cache. The scheduler unit is configured to issue the M warps to the plurality of processing cores for processing a workload, transmit the memory access request associated with the M threads, determine whether a relationship between a first hit rate of the first-level cache and a second hit rate of the second-level cache satisfies a predetermined criterion, and decrease a value of M when the predetermined criterion is satisfied. The second storage capacity is higher than the first storage capacity. The second access latency is higher than the first access latency. M is an integer larger than 1.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is functional diagram illustrating a multi-threaded processing system having a cache hierarchy according to an embodiment of the present invention.

FIG. 2 is a functional diagram illustrating a streaming multiprocessor in a multi-core processing unit according to an embodiment of the present invention.

FIG. 3 is flowchart illustrating a method of reducing cache thrashing in a processing system according to an embodiment of the present invention.

### DETAILED DESCRIPTION

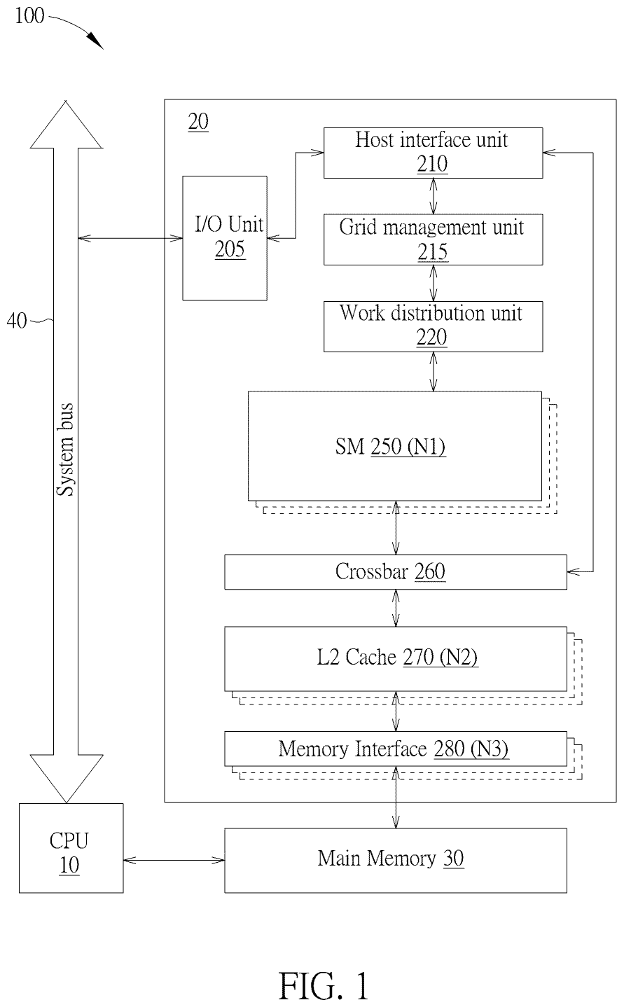

FIG. 1 is functional diagram illustrating a multi-threaded processing system 100 having a cache hierarchy according to an embodiment of the present invention. The processing system 100 includes a central processing unit (CPU) 10, a multi-core processing unit 20, a main memory 30, and a system bus 40. While a parallel processor is provided herein as an example of the multi-core processing unit 20, it should be strongly noted that such processor is set forth for illustrative purposes only, and any processor may be employed to supplement and/or substitute for the same.

In the present invention, the multi-core processing unit 20 may be included in a desktop computer, a laptop computer, a tablet computer, a smart-phone, personal digital assistant (PDA), a digital camera, a hand-held electronic device, and the like. In an embodiment, the multi-core processing unit 20 may be embodied on a single semiconductor substrate. In another embodiment, the multi-core processing unit 20 may be included in a system-on-a-chip (SoC) along with one or more other logic units such as a reduced instruction set computer (RISC) CPU, a memory management unit (MMU), a digital-to-analog converter (DAC), and the like. In yet another embodiment, the multi-core processing unit 20 may be included on a graphics card configured to interface with a motherboard of a desktop computer that includes a Northbridge chipset and a Southbridge chipset. In yet another embodiment, the multi-core processing unit 20 may be implemented as a graphics processing unit (GPU) included in the chipset (i.e., Northbridge) of the motherboard. However, the type of the processing system 100 does not limit the scope of the present invention.

In an embodiment, the main memory 30 may be implemented as a high bandwidth memory (HBM) chip, such as a 3D-stacked dual data rate synchronous dynamic random access memory (DDR SDRAM) chip. In an embodiment, the system bus 40 may adopt a high-speed serial computer expansion bus standard, such as a Peripheral Component Interconnect Express (PCIe) standard. However, the type of the main memory 30 or the system bus 40 does not limit the scope of the present invention.

As depicted in FIG. 1, the multi-core processing unit 20 may include an I/O unit 205, a host interface unit 210, a grid management unit 215, a work distribution unit 220, N1 streaming multiprocessors (SMs) 50, a crossbar 260, N2 second-level (L2) cache 270, and N3 memory interfaces 280, wherein N1-N3 are positive integers.

In the multi-core processing unit 20, the I/O unit 205 is configured to transmit and receive commands/or data over the system bus 40. In an embodiment, the I/O unit 205 may be implemented as a PCIe interface for communications over the system bus 40 which adopts PCIe standard. In alternative embodiments, the I/O unit 205 may be implemented as any type of well-known bus interfaces compatible with the system bus 40.

In the multi-core processing unit 20, the host interface unit 210 is configured to decode the commands and transmit the decoded commands to the grid management unit 215 or the memory interfaces 280 as the commands may specify. The host interface unit 210 is configured to route communications between and among the various logical units of the multi-core processing unit 20.

In the processing system 100, the main memory 30 is accessible (i.e., read/write) by both the CPU 10 and the multi-core processing unit 20. In one embodiment, the CPU 10 may execute a driver that implements an application programming interface (API) that enables one or more applications executing on the CPU 10 to schedule operations for execution on the multi-core processing unit 20. An application may include instructions (i.e., API calls) that cause the driver to generate one or more grids for execution. In one embodiment, the multi-core processing unit 20 implements a single-instruction multiple-data (SIMD) architecture wherein each thread block (i.e., warp) in a grid is concurrently executed on a different data set by different threads in the thread block. In one embodiment, the CPU 10 may write a command stream into the main memory 30 and then transmits a pointer to the start of the command stream to the multi-core processing unit 20. The host interface unit 210 may provide the grid management unit 215 with pointers to one or more streams. The grid management unit 215 may select one or more streams and organize the selected streams as a pool of pending grids. The pool of pending grids may include new grids that have not yet been selected for execution and grids that have been partially executed and have been suspended.

In the multi-core processing unit 20, the work distribution unit 220 coupled between the grid management unit 215 and the SMs 250 is configured to manage a pool of active grids, thereby selecting and dispatching active grids for execution by the SMs 50. Pending grids are transferred to the active grid pool by the grid management unit 215 when a pending grid is eligible to execute, i.e., has no unresolved data dependencies. An active grid is transferred to the pending pool when execution of the active grid is blocked by a dependency. When execution of a grid is completed, the grid is removed from the active grid pool by the work distribution unit 220. In addition to receiving grids from the host interface unit 210 and the work distribution unit 220, the grid management unit 215 also receives grids that are dynamically generated by the SMs 250 during execution of a grid. These dynamically generated grids join the other pending grids in the pending grid pool.

In an embodiment, the multi-core processing unit 20 is configured to execute a plurality of threads concurrently in two or more SMs 250. A thread (i.e., a thread of execution) is an instantiation of a set of instructions executing within a particular SM 250.

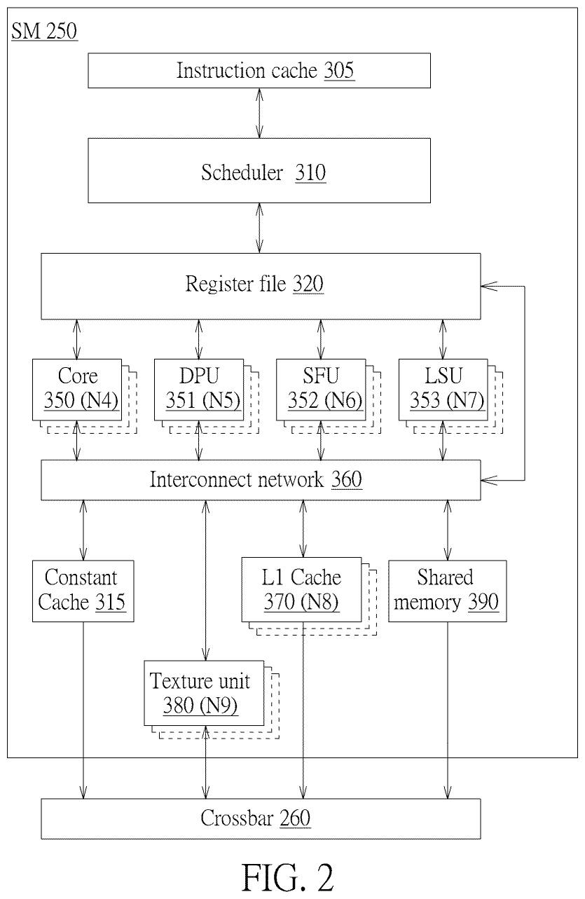

FIG. 2 is a functional diagram illustrating an SM 250 in the multi-core processing unit 20 according to an embodiment of the present invention. Each SM 250 is multi-threaded and configured to execute a plurality of threads from a particular thread block concurrently. In the embodiment depicted in FIG. 2, each SM 250 may include an instruction cache 305, a scheduler 310, a constant cache 315, a register file 320, one or more processing cores 350, one or more double precision units (DPUs) 351, one or more special function units (SFUs) 352, one or more load/store units (LSUs) 353, an interconnect network 360, one or more first-level (L1) caches 370, one or more texture units 380, and a shared memory 390.

As described above, the work distribution unit 220 depicted in FIG. 1 may dispatch active grids for execution on one or more SMs 250 of the multi-core processing unit 20 to the instruction cache 305 of the corresponding one or more SMs 250. After a specific SM 250 receives the grids from the work distribution unit 220 via its instruction cache 305, its scheduler 310 is configured to manage instruction scheduling for one or more thread blocks of each active grid. The scheduler 310 may schedule threads for execution in groups of parallel threads, where each group is called a warp. In an embodiment, each warp may include 32 threads, but is not limited thereto. The scheduler 310 may manage a plurality of different thread blocks, thereby allocating the thread blocks to warps for execution and then scheduling instructions from the plurality of different warps on the various functional units (such as the cores 350, the DPUs 351, the SFUs 352, and the LSUs 353) during each clock cycle. In an embodiment, the scheduler 310 of each SM 250 may be implemented as dedicated hardware unit configured to schedule workloads among various processing cores 350. In another embodiment, the scheduler 310 of each SM 250 may be implemented by software for scheduling workloads among various processing cores 350.

As depicted in FIG. 2, each SM 250 may include a small, latency-optimized constant cache 315 which is optimized to broadcast the results of read requests to threads that all reference the same memory location.

As depicted in FIG. 2, each SM 250 may include a register file 320 configured to provide a set of registers for the functional units of the SM 250. In an embodiment, the register file 320 may be divided between each of the functional units such that each functional unit is allocated a dedicated portion of the register file 320. In another embodiment, the register file 320 may be divided between the different warps being executed by the SM 250. The register file 320 is configured to provide temporary storage for operands connected to the data paths of the functional units.

As depicted in FIG. 2, each SM 250 may include N4 processing cores 350, wherein N4 is a positive integer. In one embodiment, the SM 250 includes distinct processing cores 350, each of which is a fully-pipelined, single-precision processing unit. Each SM 250 may also include N5 DPUs 351 that implement double-precision floating point arithmetic, N6 SFUs 352 that perform special functions, and N7 LSUs 353 that implement load and store operations between the shared memory 390 and the register file 320, wherein N5-N7 are positive integers. The shared memory 390 of each SM 250 is a very fast on-chip device that threads can use for data interchange within a thread block.

As depicted in FIG. 2, each SM 250 may include N8 L1 caches 390 for reducing memory access latency, wherein N8 is a positive integer. Each L1 cache 370 may be associated with a corresponding core 350. In an embodiment, the L1 cache 370 may be included in the shared memory 390 with a separate direct connection to the crossbar 260. The combined L1 cache and shared memory subsystem architecture significantly improves the performance of each SM 250 for both types of memory accesses.

In an embodiment when the multi-core processing unit 20 is implemented as a GPU, each SM 250 may include N9 texture units coupled between the interconnect network 360 and the shared memory 390 and coupled to the crossbar 260, wherein N9 is a positive integer. Each texture unit 380 is configured to access texture maps (i.e., a 2D array of texels) from the main memory 30 and sample the texture maps to produce sampled texture values for use in shader programs. Each texture unit 380 may implement texture operations such as anti-aliasing operations using mipmaps (i.e., texture maps of varying levels of detail).

As depicted in FIG. 1, the processing system 100 may include N2 L2 caches 270 and N3 memory interfaces 280, wherein N2 and N3 are positive integers. In the processing system 100, each SM 250 may be connected to the N2 L2 caches 270 via the crossbar 260 (or another type of interconnect network), and each L2 cache 270 may be connected to one or more memory interfaces 280. In an embodiment, each memory interface 280 may implement multi-bit data buses for high-speed data transfer between the multi-core processing unit 20 and the main memory 30. In an embodiment, the main memory 30 may include multiple memory devices each connected to a corresponding memory interface 280.

In the embodiment depicted in FIGS. 1 and 2, the processing system 100 adopts a two-level cache hierarchy, wherein one SM uses one or more dedicated L1 caches 370, while all SMs share one or more L2 caches 270. In other embodiments, the processing system 100 may adopt a cache hierarchy of more than two levels. Typically in a multi-level cache hierarchy, caches at a lower level (e.g., the L1 cache) tend to have lower storage capacity and lower access latencies, while caches at the higher level (e.g., the L2 cache) tend to have higher storage capacity and higher access latencies. Accordingly, cache lines of data are transferred among the caches of different cache levels so as to better optimize the utilization of the cache data in view of the caches' storage capacities and access latencies through cache line eviction processes and cache line installation processes.

The cache hierarchy of the multi-threaded processing system 100 work together to satisfy memory access requests, as described further herein. Data to be cached in the cache hierarchy typically is manipulated as blocks of data referred to as “cache lines”, each of which is addressed or otherwise located in the memory hierarchy using a physical address of main memory 30. Cache lines may be accessed from the main memory 30 in response to memory requests from the cache hierarchy, and the cache lines are stored, or cached, in one or more L1 caches and L2 caches of the cache hierarchy. Likewise, when a cache line containing modified data is evicted from the cache hierarchy and thus needs to be updated in the main memory 30, a write-back process may be performed.

After receiving memory access requests for data from the CPU 10, the multi-core processing unit 20 first searches the L1 cache 370 and the L2 cache 270 to determine if one of the cache entries stores a cache line associated with the memory address targeted by the memory access request. If the requested cache line is found in any of the L1 cache 370 or the L2 cache 270, a cache hit has occurred; if the requested cache line is not found any of the L1 cache 370 and the L2 cache 270, a cache miss has occurred. In the event of a cache hit, the memory access request is satisfied by, in the case of a read operation, providing the requested cache line from the appropriate cache to the CPU 10 or, in the case of a write operation, storing the write data to the appropriate cache entry. In the event of cache misses at all of the L1 caches 370 and the L2 cache 270, the memory access request is provided to the main memory 30.

In the cache hierarchy of the multi-core processing system 100, data from the main memory 30 may be fetched and stored in the L2 cache 270, which is shared between various SMs 250. As previously stated, each SM 250 has its own dedicated L1 cache 370 coupled to the shared L2 cache 270. Data from the L2 cache 270 may be fetched and stored in each of the L1 caches 370 for processing in the functional units of the SMs 250.

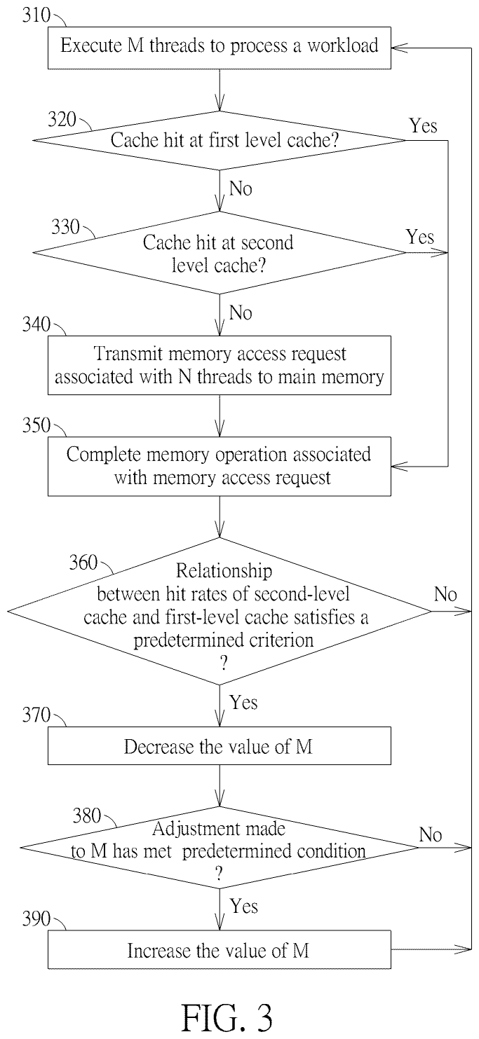

FIG. 3 is flowchart illustrating a method of reducing cache thrashing in the processing system 100 according to an embodiment of the present invention. The method depicted in FIG. 3 may be executed by the processing system 100 depicted in FIGS. 1 and 2, and includes the following steps:
Step 310: execute M threads to process a workload.
Step 320: transmit a memory access request associated with the M threads to a first-level cache and determine whether a cache hit occurs? If yes, execute step 350; if no, execute step 330.
Step 330: transmit the memory access request associated with the M threads to a second-level cache and determine whether a cache hit occurs? If yes, execute step 350; if no, execute step 340.
Step 340: transmit the memory access request associated with the M threads to a main memory; execute step 350.
Step 350: complete the operation associated with the memory access request.
Step 360: determine whether the relationship between the hit rate of the second-level cache and the hit rate of the first-level cache satisfies a predetermined criteria; if yes, execute step 370; if no, execute step 310.
Step 370: decrease the value of M; execute step 380.
Step 380: determine whether the adjustment made to the value of M has met a predetermined condition; if yes, execute step 390; if no, execute step 310.
Step 390: increase the value of M; execute step 310.

In step 310, the multi-core processing unit 20 implementing an SIMD architecture may execute M threads concurrently to process a workload, wherein M is an integer larger than 1. In an embodiment when the multi-core processing unit 20 is implemented as a GPU, the workload may include rendering a graphical user interface (GUI) and/or a graphics scene, but is not limited thereto.

In step 320, the memory access request associated with the M threads is first transmitted to the first-level cache (i.e., the L1 cache 370 of a corresponding SM 250). If an entry in the first-level cache can be found with a tag matching that of the desired data, step 350 is then executed for completing the operation associated with the memory access request. If no entry with a tag matching that of the desired data can be found in the first-level cache, step 330 is then executed.

In step 330, the memory access request associated with the M threads is then transmitted to the second-level cache (i.e., the L2 cache 270). If an entry in the second-level cache can be found with a tag matching that of the desired data, step 350 is then executed for completing the memory operation associated with the memory access request. If no entry with a tag matching that of the desired data can be found in the second-level cache, step 340 is then executed.

In step 340, the memory access request associated with the M threads is then transmitted to the main memory 30 for accessing the desired data, so that the operation associated with the memory access request may then be completed in step 350.

In the case of a read operation, the multi-core processing unit 20 is configured to satisfy the memory access request by providing the requested cache line from the L1 cache 370, the L2 cache 270 or the main memory 30 to the CPU 10 in step 350. In the case of a read operation, the multi-core processing unit 20 is configured to satisfy the memory access request by storing data into the L1 cache 370, the L2 cache 270 or the main memory 30 in step 350.

Cache misses can significantly impact system performance. When a cache miss occurs, the system must fetch the requested data from the main memory or another level of cache, which is a slower process compared to retrieving data from the cache. This delay can lead to a performance bottleneck, particularly in systems where high-speed operations are critical.

There are several types of cache misses: compulsory miss, capacity miss, conflict miss, and coherence miss. A compulsory miss occurs when data is accessed for the first time. Since the data has not been requested before, it is not present in the cache, leading to a miss. This type of miss is unavoidable as it is inherent in the first reference to the data. The only way to eliminate compulsory misses would be to have an infinite pre-fetch of data, which is not feasible in real-world systems.

A capacity miss happens when the cache cannot contain all the data needed by the system. This type of miss occurs when the working set (the set of data that a program accesses frequently) is larger than the cache size. When the cache is filled to capacity and a new data item is referenced, existing data must be evicted to accommodate the new data, leading to a miss when the evicted data is referenced again by the program. Capacity misses can be reduced by increasing the cache size or optimizing the program to decrease the size of the working set. In a multi-threaded system, it is also possible to reduce the number of threads to limit the total working set.

Conflict misses occur when multiple data items, which are accessed in a sequence, map to the same cache location, known as a cache set. This type of miss is a result of the cache's organization. In a set-associative or direct-mapped cache, different data items may be mapped to the same set, leading to conflicts. When a new item is loaded into a filled set, another item must be evicted, leading to a miss if the evicted item is accessed again. Conflict misses can be mitigated by improving the cache's mapping function or by increasing the cache's associativity.

Coherence misses are specific to multiprocessor systems. In such systems, several processors have their own private caches and access shared data. A coherence miss occurs when one processor updates a data item in its private cache, making the corresponding data item in another processor's cache stale. When the second processor accesses the stale data, a cache miss occurs. Coherence misses are managed by implementing cache coherence protocols that ensure consistency among the various caches.

The present method aims at reducing cache thrashing in the processing system 100 by detecting capacity misses. In step 360, it is determined whether the relationship between the hit rate of the second-level cache (hereafter referred to as “HR2”) and the hit rate of the first-level cache (hereafter referred to as “HR1”) satisfies a predetermined criterion set to be indicative of capacity misses. Since the first-level cache is accessed prior to the second-level cache in response to each memory access request, when the amount of data referenced by a program exceeds the capacity of the first-level cache, the relationship between HR1 and HR2 may not satisfy the predetermined criterion due to capacity misses, thereby lowering data efficiency. Under such circumstance, step 370 is then executed for decreasing the value of M. By halting the execution of a part of the context, the amount of data referenced by the workload may be decreased for reducing capacity misses at the first-level cache.

In an embodiment, the predetermined criterion is satisfied when HR2>HR1. Since the first-level cache is accessed prior to the second-level cache in response to each memory access request, when the amount of data referenced by a program exceeds the capacity of the first-level cache, a lower hit rate HR1 of the first-level cache may be attributed by capacity misses, thereby lowering data efficiency. Under such circumstance, step 370 may then be executed for decreasing the value of M.

In another embodiment, the predetermined criterion is satisfied when (HR2−HR1)>K1, wherein K1 is a predetermined value. Since the first-level cache is accessed prior to the second-level cache in response to each memory access request, when the amount of data referenced by a program exceeds the capacity of the first-level cache, a larger difference between the hit rate HR2 of the second-level cache and the hit rate HR1 of the first-level cache that exceeds the predetermined value K1 may be attributed by capacity misses, thereby lowering data efficiency. Under such circumstance, step 370 may then be executed for decreasing the value of M.

In another embodiment, the predetermined criterion is satisfied when HR2>K2, wherein K2 is a predetermined positive value. Since the first-level cache is accessed prior to the second-level cache in response to each memory access request, when the amount of data referenced by a program exceeds the capacity of the first-level cache, a larger hit rate HR2 of the second-level cache that exceeds the predetermined value K2 may be attributed by capacity misses, thereby lowering data efficiency. Under such circumstance, step 370 may then be executed for decreasing the value of M.

In step 380, it is determined whether the adjustment made to the value of M has met a predetermined condition. When the adjustment made to the value of M has met the predetermined condition, in indicates that the amount of data referenced by the workload has been sufficiently decreased so as to significantly reduce capacity misses at the first-level cache. Under such circumstance, step 390 may then be executed for increasing the value of M, thereby increasing data throughput.

In an embodiment, the predetermined condition is met when the value of M has been reduced more than K3 times, wherein K3 is a predetermined positive integer. In another embodiment, the predetermined condition is met when the difference between the original value of M and the current value of N exceeds a predetermined value. In another embodiment, the predetermined condition is met when a predetermined period of time has elapsed since the first decrease of the value of M.

In conclusion, the present invention provides a zero-overhead method of reducing cache thrashing in a multi-threaded processing system by detecting capacity misses. The size of the workload can thus be dynamically monitored and adjusting for improving cache efficiency.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of reducing cache thrashing in a processing system, comprising:
issuing M threads to process a workload;
transmitting a memory access request associated with the M threads to a first-level cache of the processing system and determining whether a first cache hit or a first cache miss occurs at the first-level cache;
transmitting the memory access request associated with the M threads to a second-level cache of the processing system in response to the first cache miss and determining whether a second cache hit or a second cache miss occurs at the second-level cache;
transmitting the memory access request associated with the M threads to a main memory of the processing system in response to the second cache miss;
determining whether a relationship between a first hit rate of the first-level cache and a second hit rate of the second-level cache satisfies a predetermined criterion; and
decreasing a value of M when the predetermined criterion is satisfied, wherein:
a storage capacity of the second-level cache is higher than a storage capacity of the first-level cache;
an access latency of the second-level cache is higher than an access latency of the first-level cache; and
M is an integer larger than 1.

2. The method of claim 1, wherein:
the predetermined criterion is satisfied when the second hit rate is higher than the first hit rate.

3. The method of claim 1, wherein:
the predetermined criterion is satisfied when the second hit rate is higher than the first hit rate by more than a predetermined value.

4. The method of claim 1, wherein:
the predetermined criterion is satisfied when the second hit rate is higher than a predetermined positive value.

5. The method of claim 1, wherein:
a storage capacity of the main memory is higher than the storage capacity of the second-level cache;
an access latency of the main memory is higher than the access latency of the second-level cache.

6. The method of claim 1, further comprising:
providing, by the first-level cache, data requested by the memory access request for completing an operation associated with the memory access request in response to the first cache hit.

7. The method of claim 1, further comprising:
providing, by the second-level cache, data requested by the memory access request for completing an operation associated with the memory access request in response to the second cache hit.

8. The method of claim 1, further comprising:
providing, by the main memory, data requested by the memory access request for completing an operation associated with the memory access request in response to the first cache miss and the second cache miss.

9. The method of claim 1, further comprising:
determining whether an adjustment made to the value of M has met a predetermined condition; and
increasing the value of M when the predetermined condition is met.

10. The method of claim 9, wherein the predetermined condition is met when:
the value of M has been reduced more than K times;
a difference between an original value of M and a current value of N exceeds a predetermined value; or
a predetermined period of time has elapsed since a first decrease of the value of M.

11. A processing system which reduces cache thrashing, comprising:
a plurality of processing cores;
a first-level cache with a first storage capacity and a first access latency, and configured to:
receive a memory access request associated with M threads; and
determine whether a first cache hit or a first cache miss occurs at the first-level cache;
a second-level cache with a second storage capacity and a second access latency, and configured to:
receive the memory access request associated with the M threads from the first-level cache in response to a first cache miss at the first-level cache; and
determine whether a second cache hit or a second cache miss occurs at the second-level cache; and
a main memory configured to receive the memory access request associated with the M threads from the second-level cache in response to a second cache miss at the second-level cache; and
a scheduler configured to:
issue the M threads to the plurality of processing cores for processing a workload;
transmit the memory access request associated with the M threads to the first-level cache;
determine whether a relationship between a first hit rate of the first-level cache and a second hit rate of the second-level cache satisfies a predetermined criterion; and
decrease a value of M when the predetermined criterion is satisfied, wherein:
the second storage capacity is higher than the first storage capacity;
the second access latency is higher than the first access latency; and
M is an integer larger than 1.

12. The processing system of claim 11, wherein:
the predetermined criterion is satisfied when the second hit rate is higher than the first hit rate.

13. The processing system of claim 11, wherein:
the predetermined criterion is satisfied when the second hit rate is higher than the first hit rate.

14. The processing system of claim 11, wherein:
the predetermined criterion is satisfied when the second hit rate is higher than a predetermined positive value.

15. The processing system of claim 11, wherein:
a third storage capacity of the main memory is higher than the second storage capacity; and
a third access latency of the main memory is higher than the second access latency.

16. The processing system of claim 11, wherein the first-level cache is further configured to provide data requested by the memory access request to the plurality of processing cores in response to the first cache hit for completing the operation associated with the memory access request.

17. The processing system of claim 11, wherein the second-level cache is further configured to provide data requested by the memory access request to the plurality of processing cores in response to the second cache hit for completing the operation associated with the memory access request.

18. The processing system of claim 11, wherein the main memory is configured to provide data requested by the memory access request to the plurality of processing cores in response to the first cache miss and the second cache miss for completing the operation associated with the memory access request.

19. The processing system of claim 11, wherein the scheduler is further configured to:
determine whether an adjustment made to the value of M has met a predetermined condition; and
increase the value of M when the predetermined condition is met.

20. The processing system of claim 11, wherein the plurality of processing cores, the scheduler and the first-level cache are implemented as a streaming multiprocessor (SM).
